(19) United States
(12) Patent Application Publication
(10) Pub. No.: US 2011/0202407 A1
(43) Pub. Date: Aug. 18, 2011

(54) SYSTEM AND METHOD FOR IMPROVING INTERNET SEARCH RESULTS USING TELECOMMUNICATIONS DATA

(75) Inventors: Michael F. Buhrmann, North Bend, WA (US); Devin P. Miller, North Bend, WA (US); Randall A. Snyder, Las Vegas, NV (US)

(73) Assignee: FINSPHERE CORPORATION, Bellevue, WA (US)

(21) Appl. No.: 13/030,759

(22) Filed: Feb. 18, 2011

Related U.S. Application Data
(60) Provisional application No. 61/305,830, filed on Feb. 18, 2010.

(51) Int. Cl. G06Q 30/00; G06F 17/30

(52) U.S. Cl. 705/14.54; 707/758; 707/E17.005

(57) ABSTRACT

A method of displaying advertising to a user includes receiving a request including search terms from the user, receiving a mobile directory number associated with the user, requesting telecommunications data based on the mobile directory number, receiving the telecommunications data, determining advertising results based on the search terms and the telecommunications data, and displaying the advertising results to the user.

### CROSS REFERENCES TO RELATED APPLICATIONS

This application claims priority to and the benefit of the filing date of U.S. Provisional Patent Application No. 61/305,830 filed Feb. 18, 2010, which is hereby incorporated by reference in its entirety.

### BACKGROUND OF THE INVENTION

Online search allows individuals to more easily find information on networks such as the World Wide Web on the Internet. Consumers typically type a keyword or phrase into a search engine and results are displayed that best match the search. Generally, when a user enters a search term into the search engine, the displayed results are produced using data elements from various sources that typically include the World Wide Web (results shown are processed using a search algorithm), user internet protocol (IP) address information for generating location information about the user, and cookies placed on the user's computer by the search engine to track preferences.

Advertisements are also typically displayed to the user based on their search request. When an advertiser uses an online search engine for search marketing, they pay to place targeted advertisements in relation to particular searches. For example, an advertisement for bill pay providers will be displayed when someone performs a search using the keyword phrase “bill pay.” The advertiser pays a per-click price to drive clicks to a webpage when the user clicks their bill pay advertisement. The advertiser typically bids on particular key words, such as “bill pay” in the example above, which in turn results in their advertisement being displayed when an online user searches the term the advertiser has bid on. The cost per click (hereinafter “CPC”) may vary from several cents to $20 or more. The frequency and ranking of an advertiser's ad depends on their monthly budget and the amount they bid per click.

Once a user clicks on an advertiser's advertisement, the user is most commonly taken to what is called a landing page or simply the advertiser's desired webpage. After the user is at the landing page, the advertiser typically aims to have the user complete some action such as filling out a submission form field, calling the advertiser or continuing to another webpage. Typically the action desired by the advertiser will result in a sales lead.

The final cost of the lead is based on the volume of paid ad clicks it took before a user fills out a lead. For example, this number might be 1 in 10 meaning 1 in 10 users who see the landing page submit a lead. This means that if the CPC of an ad is $1 and the lead rate is 10% the cost of the lead was $10.

For users searching for high value services such as insurance or financial products, the CPC can be $20 or more and the lead cost can be several hundred dollars. Furthermore, the leads are not qualified leads and the advertiser is typically left with little if any information on the users who clicked to get to the landing page and did not fill out any information.

Managing the costs and return on investment (ROI) of an online advertising campaign and generating quality leads from the submissions is a challenging process for online advertisers. Some tools are available that can be used to analyze the performance of advertising campaigns and adjust settings to maximize the results. However, these tools are structured to maximize traffic and minimize lead generation costs. A core problem with online advertising is ensuring that the right advertisements are seen by the right target customer. Currently available tools are limited in their ability to help advertisers match the right advertisements with the right key words to attract the right sales leads and potential buyers having characteristics desired by the advertisers.

In the “bill pay” example above, such a simple and commonly searched term can be difficult to manage based on the wide array of people searching the term.

### BRIEF DESCRIPTION OF THE DRAWINGS

Preferred and alternative examples of the present invention are described in detail below with reference to the following drawings:

FIG. 1 is a diagram of a system for generating improved internet search results in accordance with an embodiment of the invention;

FIG. 2 is a flowchart of a method of generating improved internet search results based on mobile telecommunications data in accordance with an embodiment of the invention;

FIG. 3 is a depiction of a graphical user interface for setting qualification settings in accordance with an embodiment of the invention; and

FIG. 4 is a depiction of a graphical user interface for a campaign management system in accordance with an embodiment of the invention.

### DETAILED DESCRIPTION OF THE PREFERRED EMBODIMENT

Systems and methods for improving Internet search results using telecommunications data are disclosed herein. In accordance with some examples of the invention, a method of displaying advertising to a user includes receiving a request including search terms from the user, receiving a mobile directory number (MDN) associated with the user, requesting telecommunications data based on the mobile directory number, receiving the telecommunications data, determining advertising results based on the search terms and the telecommunications data, and displaying the advertising results to the user.

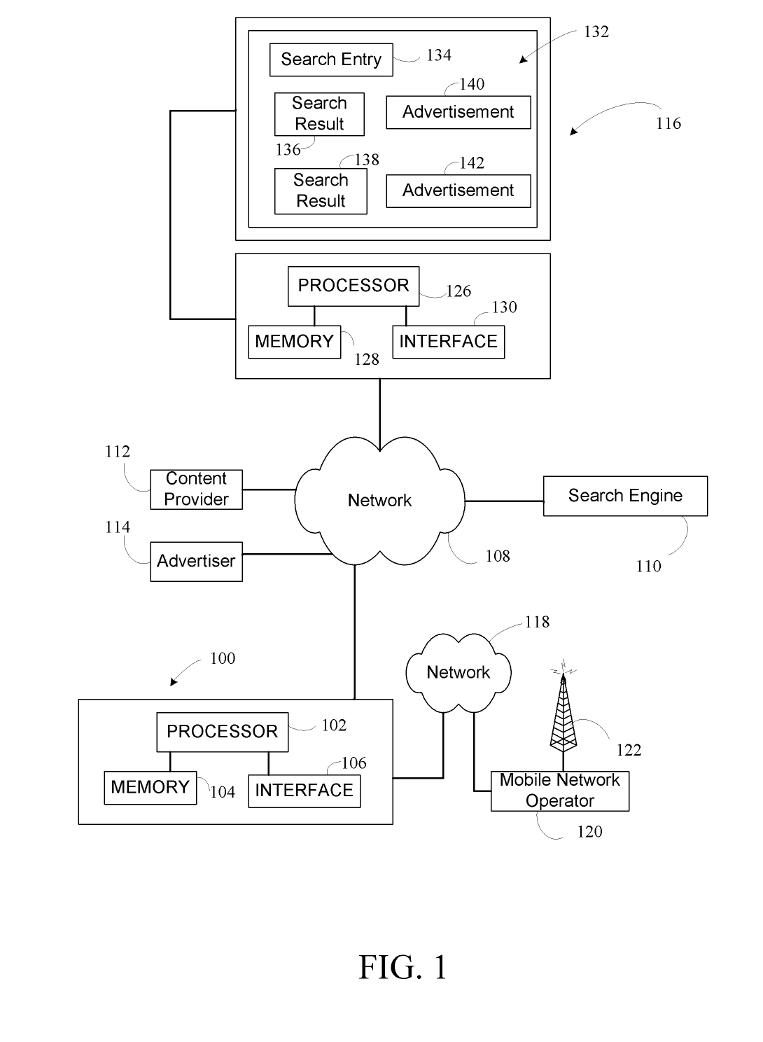

FIG. 1 is a diagram of a system 100 for generating improved internet search results in accordance with an embodiment of the invention. The system 100 is referred to as a telecommunications data analysis system in an example embodiment of the invention. The system 100 includes a processor 102 in signal communication with a memory 104 and a network interface 106. The system 100 is in data communication with a network 108, such as the Internet. A search engine 110, a content provider 112, an advertiser 114, and a computing device 116 are also shown in data communication with the network 108. In some embodiments a content provider 112 may be an advertiser 114 and/or an advertiser 114 may be a content provider 112. The search engine 110 is typically a search engine website that a consumer uses to search the Internet and that advertisers use to post ads to consumers while they search. The advertiser 114 posts ads on the search website and uses analytics and reporting tools provided by the search engine to track campaign performance. Advertisements are selected to be shown based on the campaign settings an advertiser sets.

The system 100 is also in data communication with a second network 118 that is in data communication with a mobile network operator 120. The mobile network operator 120 is typically a wireless telecommunications network operator that provides information related to the MDN to the system 100 for integration into search and analytics tools. A wireless communications network 122 is also in data communication with the mobile network operator 120. Although the system 100 is shown to be in data communication with the mobile network operator 120 through the second network 118, the system 100 may also communicate with the mobile network operator 120 in another manner, such as through the network 108 or through the wireless network 122, for example. Although the search engine 110, the content provider 112, the advertiser 114, and the mobile network operator 120 are not shown in detail, it should be understood that they each include computerized systems in data communication with one or more networks. In an example embodiment, the system 100 gathers and integrates telecommunications network information into the search engine for the purpose of improving search results, analyzing the performance of an advertising campaign and qualifying leads. Telecommunications data can be used to develop a demographic profile about the user performing the search thus allowing advertisers to qualify which advertisements are displayed to what users searching for a particular term. In some embodiments other factors are included when improving search results and qualifying leads; those factors include, but are not limited to, current location, historical location data, location trends, mobile subscriber demographic data and/or historic behavior.

The computing device 116 includes a processor 126 in data communication with a memory 128 and a network interface 130 that connects to a network through a wired and/or wireless connection. The network may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The computing device 116 may include desktop computing systems, notebook computers, mobile phones, smart phones, personal digital assistants, and the like. The computing device 116 further includes a display 132. A search entry 134, a first search result 136, a second search result 138, a first advertisement 140, and a second advertisement 142 are shown on the display 132. The computing device 116 also includes a user input device, such as a keyboard, but other user input devices may also be used, such as by using a touch sensitive screen as the display 132, for example.

In one example embodiment, the system 100 gathers telecommunications data from the appropriate network such as the mobile network operator 120, retrieving basic information related to the MDN such as the average monthly revenue for the user, account standing, and other information available from the mobile network operator 120. This information is then processed based on parameter settings the search engine has provided to the system 100 from qualification settings previously set by the advertiser 114. For example, if the of the MDN is $50, the system 100 determines if the amount is average, above average, below average, or related in some other way to a predetermined parameter. This determination is sent from the system 100 to the search engine 110 so that advertising results can be determined for display on the computing device 116.

Typically, preferences of an online user are commonly tracked using IP address information or with cookies placed on a user's computer. Both can be used to trace some level of location information and preferences for particular types of advertising and online information. For example, the IP address will demonstrate what approximate region a user is currently searching from, allowing the search engine to localize results and the cookie placed on the user computer will provide historical information of what advertisements and websites are most frequented or most likely to be clicked by a particular user. By leveraging telecommunications data, much utility is gained by using more granular, real-time location data to pin point a user and deliver more relevant advertisements. Further, by integrating telecommunications data such as credit worthiness, payment history and demographic information as well other information available to telecommunications providers, the quality of advertising campaigns is increased by adding these additional filtering elements.

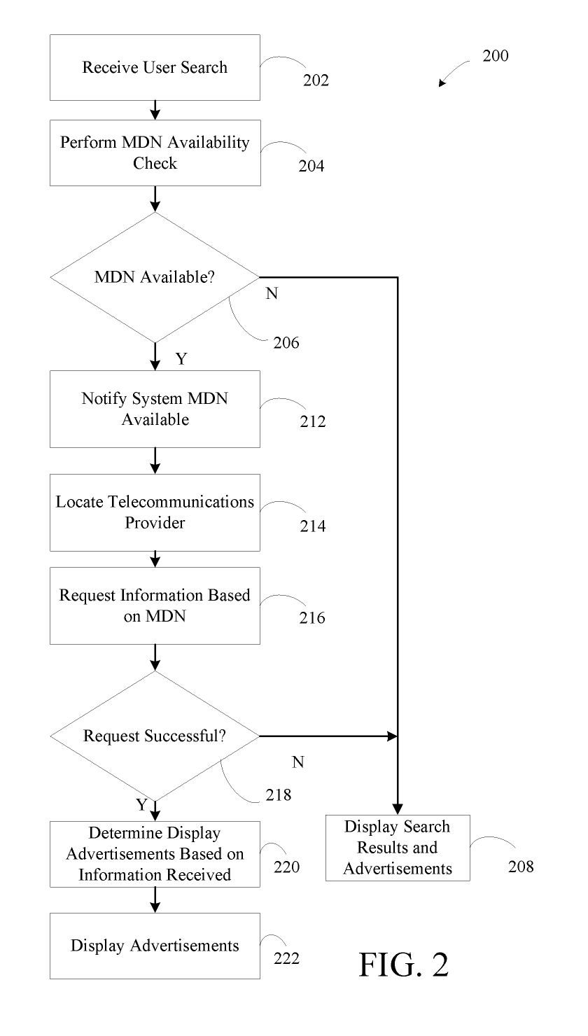

FIG. 2 is a flowchart of a method 200 of generating improved Internet search results based on mobile telecommunications data in accordance with an embodiment of the invention. First, at a block 202, a user search is received. This may occur by a user entering a search query with the computing device 116 that is sent to the search engine 110, for example. Next, at a block 204, a mobile directory number availability check is performed by the search engine 110. Then, at a decision block 206, it is determined whether the MDN was available. If the MDN was not available, the search engine is notified that no data is available, then, at a block 208, search results and advertisements are displayed based on results determined in a conventional manner.

If it was determined the MDN was available at the decision block 206, the system 100 is notified by the search engine 110 that the MDN is available at a block 212. The MDN may be provided or obtained in a variety of ways. In an example embodiment, the consumer user is provided with the option of typing in their MDN along with their search terms on the computing device 116. A text box is displayed allowing the consumer user to enter their MDN along with the keywords or terms they wish to search. In an additional embodiment, the consumer user has previously registered with the search engine 110, including entering their MDN into a profile database, with this profile being used to store the MDN that is then provided to the system 100 by the search engine 110.

In a further embodiment, the consumer user performs the search using a wireless device such as a mobile phone, a netbook or other computing device with wireless access such as through a wireless networking card, or through some other device connected to the World Wide Web and search engine 110 through a wireless connection. In this example embodiment, the MDN or a different device identifier such as an International Mobile Equipment Identity (IMEI) number can used by the system 100 to access telecommunications data from the mobile network operator 120.

Then, at a block 214, a telecommunications provider corresponding to the MDN, such as the mobile network operator 120, is determined. Next, at a block 216, information based on the MDN is requested from the telecommunications provider by the system 100. Then, at a decision block 218, it is determined whether the request for information was successful. If the request was successful, the requested information from the telecommunications provider, based on the MDN, is transmitted to the search engine such that display advertisements are determined by the search engine 110 at a block 220. Then, the determined advertisements are displayed on the computing device 116 at a block 222. If it was determined that the request was not successful at the decision block 218, the method 200 proceeds to the block 208 where the search engine is notified that no data is available.

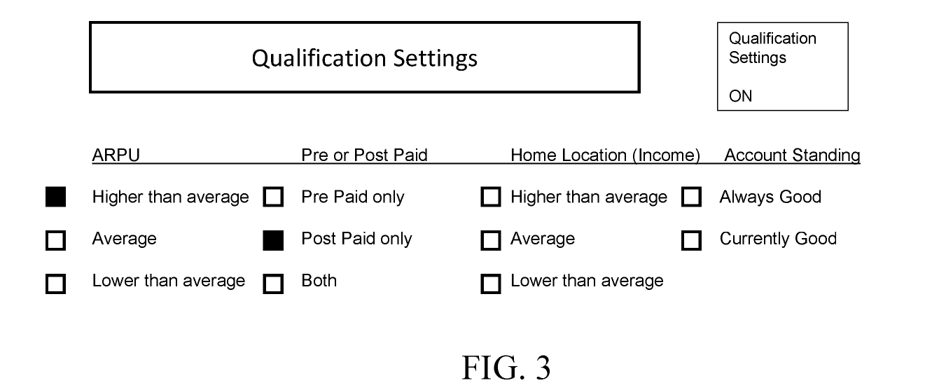

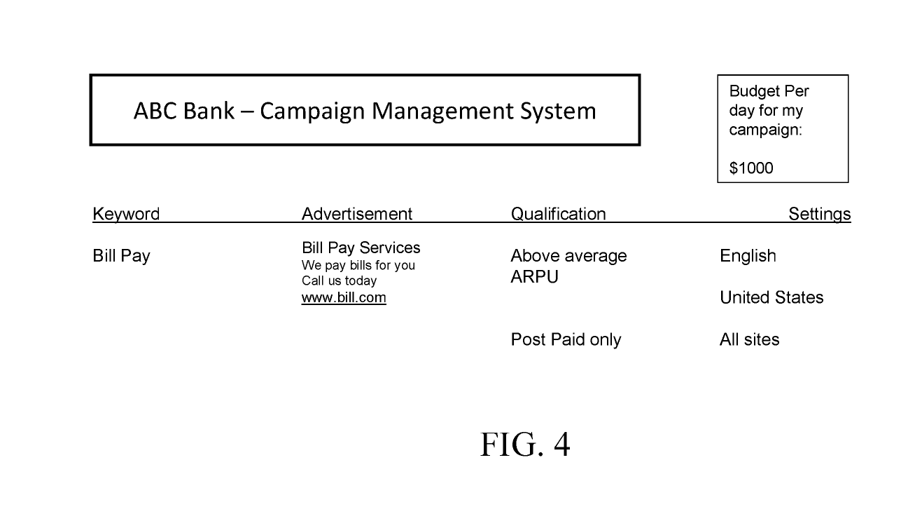

In an example embodiment, information is received by the system 100 from the mobile network operator 120 in response to the request for information at the block 216. This information may be in the form of raw data, such as the average revenue for the user of $90 per month, for example. In this example, the following steps take place in the block 220. The system 100 processes the raw information to obtain data elements that are sent to the search engine 110. For example, the system 100 has a previously stored ARPU average look-up table in an example embodiment and compares the raw received average revenue for a specific user information to the average for all users in the ARPU look-up table. For example, if the ARPU average in the look-up table is $50 per month, revenue per month for the user associated with the MDN of $90 per month would be determined to be above average. The above average revenue data element would then be sent to the search engine 110 from the system 100 and the search engine 110 would use this data element in combination with qualification settings previously supplied by the advertiser 114 as described with respect to FIGS. 3 and 4 to determine which advertisements to display on the computing device 116 at the block 222.

To further elaborate by way of example, if a user performs a search for “mortgage” and the MDN is not available, the advertiser 114 could decide to not display an advertisement at all based on settings previously given to the search engine 110. If a user performs a search, the MDN is available, telecommunications data is provided, and the system 100 determines that the area code of the user is in an area with a higher than average income and the MDN is post-paid, then the advertisers advertisement will be displayed based on the settings previously given to the search engine 110 such as by using a graphical user interface such as those described with respect to FIGS. 3 and 4.

This method provides utility to advertisers by giving them greater control over campaigns and when they are shown, resulting in a higher clickthrough rate (CTR), lower CPC, greater lead generation rate and higher close ratio based on pre-qualifying the users who can view and click on an advertisement. It also provides utility to the user by presenting advertisements that are more relevant to them than previous methods.

FIG. 3 is a depiction of a graphical user interface for setting qualification settings in accordance with an embodiment of the invention. These settings are set by the advertiser 114 shown in FIG. 1 and provided to the search engine 110 in an example embodiment. The settings are then used by the search engine 110 to determine advertisements based on information received from the system 100 as described with respect to block 220 in FIG. 2.

In the example shown, the graphical user interface includes qualification settings for average revenue for the specific user, pre-paid vs. post-paid status, home location income level, and account standing. The average revenue setting allows selections for higher than average, average, and lower than average. The higher than average setting is shown with a darkened selection box, while the average and lower than average selection boxes have not been selected. The pre-paid vs. post-paid setting allows selections for pre-paid only, post-paid only, and both. The post-paid only box has been selected in this example. The home location income level setting allows selections for higher than average, average, and lower than average. None of the selections are darkened, indicating this setting will not be used to filter and/or determine advertising results. Home location income level may be determined in a variety of ways. For example, the home postal code of the subscriber may be used to determine income level based on postal code. The account standing setting allows selections for always good and currently good. These selections are based on whether the mobile network operator (MNO) has historically been owed an outstanding balance and whether the MNO is currently owed an outstanding balance. Neither of the selections are darkened, indicating this setting will not be used to filter and/or determine advertising results.

In addition to the settings mentioned above and shown in FIG. 3, other settings based on additional information from the mobile network operator may be used to filter and manage which advertisements are shown to search users. As examples, the area code of the MDN may be used to determine likely home location, the late fee history including whether the MNO has charged late fee penalties to bills of the subscriber may be used, the general location as determined by serving cell ID at the time of the search, whether the MDN provided is real or fake, whether the MDN provided is known to be associated with cases of fraud, whether the MDN is on a family plan or a business account and the data found does not specifically match that of a consumer to control for incorrect profile information, and the age and gender of the subscriber account associated with the MDN.

The advertiser will have the capability to dictate that an advertisement only be displayed based on the advertisers preference around profile requirements. For example, if an advertiser is running an advertisement for a jumbo loan mortgage program (or higher than average loan value) then the advertiser could establish settings in their advertisement campaign that states that they only wish for their advertisement to be displayed for the search term “mortgage” in higher than average income areas (based on area code) and for users that have post paid phone accounts. When a user performs a search, if the MDN is available and the telecommunications data can be accessed, the system would match only advertisements that fit the profile outlined.

FIG. 4 is a depiction of a graphical user interface for a search marketing campaign management system in accordance with an embodiment of the invention. This graphical user interface could be used to manage settings such as those shown in FIG. 3 for a number of different advertisements, for example.

Online advertisers such as the advertiser 114 in FIG. 1 use a high level of analytics to manage campaigns. They track and monitor many different statistics such as cost per click (CPC), cost per lead (CPL) and click through rate (CTR) as well as the overall behavior and performance of different ads and landing pages. By leveraging generic, non-identifying data on the users who are searching, the advertiser can better manage campaigns and control spending as well as experience an increased overall return on the advertising investment compared to previous systems. Additionally, search engines such as those offered by the search engine 110 shown in FIG. 1, will be able to offer greater control and flexibility to the advertisers using a system such as the system 100. Campaigns that use the system 100 will most likely pay a higher CPC based on the more competitive bidding that will result based on the narrower requirements. Further, advertisers will most likely expand their campaigns and increase advertising spending as the return on investment improves.

Generally, if the search engine 110 has installed components that allow qualification settings based on telecommunications information, the advertiser 114 will then be able to manipulate the qualification settings as seen in FIGS. 3 and 4. The search engine will typically allow the advertiser 114 to decide which qualification settings are used in determining whether an advertisement is displayed.

While the preferred embodiment of the invention has been illustrated and described, as noted above, many changes can be made without departing from the spirit and scope of the invention. For example, the system 100 may be integrated into the search engine 110 rather than operating as a separate third-party service provider over a network or the mobile network operator 120 may be in data communication with the system 100 over a network other than the network 118, such as the network 108 or the wireless network 122. Additionally, although the method 200 has been described with respect to the display of advertisements based on telecommunications data, it should be understood that the method may also apply to the determination and display of other types of results based on telecommunications data such as improved search results from improved localization for example. Further, it should be understood that the search engine 110 may be able to provide improved analytics to the advertiser 114 based on the systems and method described such as by providing breakdowns of advertisements displayed in relation to various telecommunications data related settings such as those described with respect to FIGS. 3 and 4. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method in a computing system, comprising:
providing a telecommunications data analysis environment for a plurality of computing devices by:
receiving a search request from a computing device;
receiving an identification indicator of the mobile device;
receiving telecommunications data related to the identification indicator of the mobile device from a telecommunications network operator;
determining advertising results based on the search request and qualifying data derived from the received telecommunication data ; and
providing the determined advertising results to the computing device for display to the user.

2. The method of claim 1 further comprising:
requesting telecommunications data related to the mobile device from a telecommunications network operator.

3. The method of claim 2 wherein the telecommunications data is at least one of a user name, user address, user postal code, user account standing, user payment history, pre-paid data, post-paid data, handset type, current mobile location and historical mobile location.

4. The method of claim 3 further comprising:
receiving the requested telecommunications data; and
updating the determined advertising results based on the received telecommunications data.

5. The method of claim 4 further comprising:
receiving an indication that the user selected one or more of the provided advertising results; and
providing an advertiser with an indication that a user selected one or more of the provided advertising results and telecommunications data of the mobile device that provided the indication the user selected one or more of the provided advertising results.

6. The method of claim 5 further comprising:
providing the advertiser with a campaign management system that is configured to enable the advertiser to track statistics of one or more advertising campaigns.

7. The method of claim 6 wherein the indicator of the mobile device is a mobile directory number.

8. The method of claim 1 further comprising:
determining search results based on the search request and qualifying data derived from the received telecommunication data; and
providing the search results to the mobile device for display to the user.

9. The method of claim 1 further comprising:
receiving a request from the computing device to create a user profile with a mobile directory number.

10. A method in a client device, comprising:
facilitating an advertisements for a search marketing service by:
transmitting a search request to a telecommunications data analysis system;
transmitting to the remote system an indication an identification indicator of the mobile device;
receiving from the remote system advertising results based on the transmitted search request and the indicator of the mobile device; and
presenting the advertising results on a display to the user.

11. The method of claim 10 further comprising:
receiving from the remote system updated advertising results based on telecommunications data related to the mobile device; and
presenting the advertising results on a display to the user.

12. The method of claim 11 wherein the indicator of the mobile device is a mobile directory number.

13. The method of claim 12 further comprising:
receiving from the remote system search results based on the transmitted search request and the identification indicator of the mobile device; and
presenting the search results on the display to the user.

14. A computing system configured to facilitate a telecommunications data analysis environment, comprising:
a memory;
a module stored on the memory that is configured, when executed, to:
receive a request for information from a mobile device;
receive an indicator of telecommunication data from the mobile device;
determine results based on the request for information and the indicator of telecommunication data from the mobile device; and
provide the results to the computing device for display to the user.

15. The computing system of claim 14 wherein the module includes software instructions for execution in the memory of the computing system.

16. The computing system of claim 15 wherein the requested information is requested search information.

17. The computing system of claim 16 wherein the telecommunications data is at least one of a location of the mobile device, user name, user address, user postal code, user account standing, user payment history, and average revenue per user.

18. A computer-readable medium whose contents, when executed, cause a computing system to facilitate advertisement campaign management, by performing a method comprising:
receiving a search request from a mobile device;
receiving a mobile device number;
requesting telecommunications data related to the mobile device from a telecommunications network operator;
receiving the requested telecommunications data;
determining advertising results based on the search request, the received telecommunications data, the mobile device number; and
providing the advertising results to the mobile device for display to the user.

19. The computer-readable medium of claim 18 wherein the computer-readable medium is at least one of a memory in a computing device or a data transmission medium transmitting a generated signal containing the contents.

20. The computer-readable medium of claim 19 wherein the contents are instructions that, when executed, cause the computing system to perform the method.
